(19) United States
(12) Patent Application Publication
(10) Pub. No.: US 2025/0284556 A1
(43) Pub. Date: Sep. 11, 2025

(54) MANAGEMENT SYSTEM, MANAGEMENT METHOD, AND MANAGEMENT PROGRAM

(71) Applicant: Hitachi Vantara, Ltd., Yokohama (JP)

(72) Inventors: Takuma OJIRO, Tokyo (JP); Shinichi HAYASHI, Tokyo (JP)

(73) Assignee: Hitachi Vantara, Ltd., Yokohama-shi (JP)

(21) Appl. No.: 18/886,181

(22) Filed: Sep. 16, 2024

(30) Foreign Application Priority Data
Mar. 7, 2024 (JP) 2024-035391

(51) Int. Cl. G06F 9/50

(52) U.S. Cl. CPC G06F 9/5077; G06F 9/5044; G06F 9/5088

(57) ABSTRACT

A technique for reducing the cost of resources used for loading data while securing sufficient freshness of data, whereby a management server is provided that manages a resource scale of a virtual machine that executes processing for copying data accumulated by a first information system to a second information system. The management server includes a processor and a memory. The memory stores a data freshness threshold that defines a boundary value related to freshness of data stored in the second information system, and a virtual machine load upper limit threshold that defines an upper limit of a load on the virtual machine. When freshness of data changed in the first information system is lower than the data freshness threshold, the processor compares the load on the virtual machine with the virtual machine load upper limit threshold, and increases a resource scale of the virtual machine based on a comparison result.

### BACKGROUND OF THE INVENTION

### 1. Field of the Invention

The present disclosure relates to a technique of managing the scale of a virtual machine that executes processing of loading data in a database into another database.

### 2. Description of Related Art

In recent years, data-driven decision making of analyzing data acquired by a business system to make a decision using the data has become important. The data acquired by the business system is loaded from a database of the business s system to an analysis system and is analyzed by the analysis system. Since data is frequently updated in the database of the business system, it is important to provide fresh data for analysis.

In order to maintain high freshness of data to be analyzed, it is sufficient to frequently load the data from the business system to the analysis system. However, if data is to be frequently loaded, the cost required for allocating resources such as virtual machines necessary for loading data increases. Therefore, it is required to reduce the cost required for allocating resources used for loading data while securing sufficient freshness of data to be analyzed.

PTL 1 discloses a technique of adjusting a time interval for copying data from a business system to an analysis system based on a data update amount in the business system.

### CITATION LIST

### Patent Literature

PTL 1: JP2023-135787A

### SUMMARY OF THE INVENTION

According to the technique disclosed in PTL 1, it is possible to provide the analysis system with data having freshness satisfying requirements. However, in general, an update amount of data in a business system varies with time. In order to normally maintain sufficient freshness of data, it is necessary to secure resources having a size sufficient to execute copying at a time interval between peaks of the data update amount. However, the resources are excessive except when the data update amount is at the peak.

An object of the present disclosure is to provide a technique for reducing the cost of resources used for loading data while securing sufficient freshness of data.

A management system according to an embodiment of the present disclosure is a management system for managing a resource scale of a virtual machine that executes processing for copying data accumulated by a first information system to a second information system, the management system including: a processor; and a memory. The memory stores a data freshness threshold that defines a boundary value related to freshness of data stored in the second information system and a virtual machine load upper limit threshold that defines an upper limit of a load on the virtual machine. The processor compares the load on the virtual machine with the virtual machine load upper limit threshold when freshness of data changed in the first information system is lower than the data freshness threshold, and increases the resource scale of the virtual machine based on a comparison result.

According to the present disclosure, it is possible to provide a technique for reducing the cost of resources used for loading data while securing sufficient freshness of data.

### BRIEF DESCRIPTION OF THE DRAWINGS

FIG. 1 is a diagram illustrating a schematic overall configuration of a according to an system embodiment of the present disclosure;

FIG. 2 is a block diagram illustrating a functional configuration of a business database server illustrated in FIG. 1; FIG. 3 is a block diagram illustrating a functional configuration of a storage illustrated in FIG. 1;

FIG. 4 is a block diagram illustrating a functional configuration of a data migration virtual machine illustrated in FIG. 1;

FIG. 5 is a block diagram illustrating a functional configuration of a data loading virtual machine illustrated in FIG. 1;

FIG. 6 is a block diagram illustrating a functional configuration of a management server illustrated in FIG. 1;

FIG. 7 is a diagram illustrating details of an information table included in a change data file;

FIG. 8 is a diagram illustrating an information table of database server information stored in a memory of the management server illustrated in FIG. 6;

FIG. 9 is a diagram illustrating an information table of data migration virtual machine information stored in the memory of the management server illustrated in FIG. 6;

FIG. 10 is a diagram illustrating an information table of data loading virtual machine information stored in the memory of the management server illustrated in FIG. 6;

FIG. 11 is a diagram illustrating an information table of data loading requirement information stored in a memory of the management server illustrated in FIG. 6;

FIG. 12 is a diagram illustrating an information table of virtual machine threshold information stored in the memory of the management server illustrated in FIG. 6;

FIG. 13 is a diagram illustrating an information table of data migration virtual machine maximum size information stored in the memory of the management server illustrated in FIG. 6;

FIG. 14 is a diagram illustrating an example of a requirement input screen displayed on a display device of a management server or a display device of a terminal device of a manager by executing a requirement input screen function by a CPU of the management server;

FIG. 15 is a flowchart illustrating processing of a data migration service by a data migration system;

FIG. 16 is a flowchart illustrating data loading processing based on an analysis database;

FIG. 17 is a flowchart illustrating processing in which the management server executes scaling of a virtual machine; and

FIG. 18 is a flowchart illustrating processing in which the management server executes scaling down of a virtual machine.

### DESCRIPTION OF EMBODIMENTS

Hereinafter, an embodiment of the present disclosure will be described with reference to the drawings.

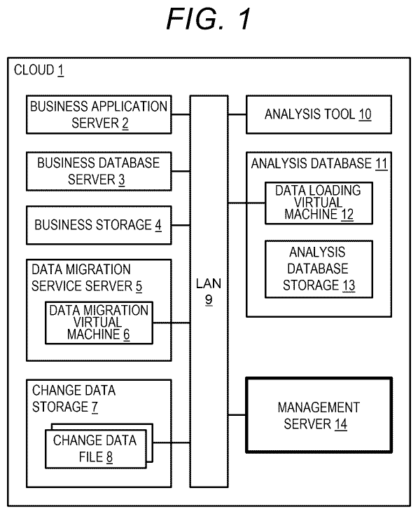

FIG. 1 is a diagram illustrating a schematic overall configuration of a system according to an embodiment of the present disclosure. As illustrated in FIG. 1, each system according to the embodiment of the present disclosure may be constructed on a cloud service 1 (hereinafter, also simply referred to as “cloud 1”) provided by a cloud computing service provider, for example. As such a cloud computing service, for example, Amazon Web Service (AWS (trademark)) provided by an American company Amazon can be used.

In the cloud 1 in the embodiment, a business application server 2, a business database server 3, a business storage 4, a data migration service server 5, a change data storage 7, an analysis tool 10, an analysis database 11, and a management server 14 are constructed. These components are communicably connected to one another via a local area network (LAN) 9. Among these components, the business application server 2, the business database server 3, and the business storage 4 constitute a business system, the data migration service server 5 and the change data storage 7 constitute a data migration system, the analysis tool 10 and the analysis database 11 constitute an analysis system, and the management server 14 constitutes a management system that manages these systems.

First, the business system will be described.

The business application server 2 in the business system executes a business application related to business provided by the business system. Examples of the business include, but are not limited to, banking business, credit card settlement business, and stock transaction business. The business application server 2 includes a central processing unit (CPU) that executes processing, and a memory that stores one or more pieces of application software and stores data necessary for executing processing, intermediate data generated in the course of processing, and the like.

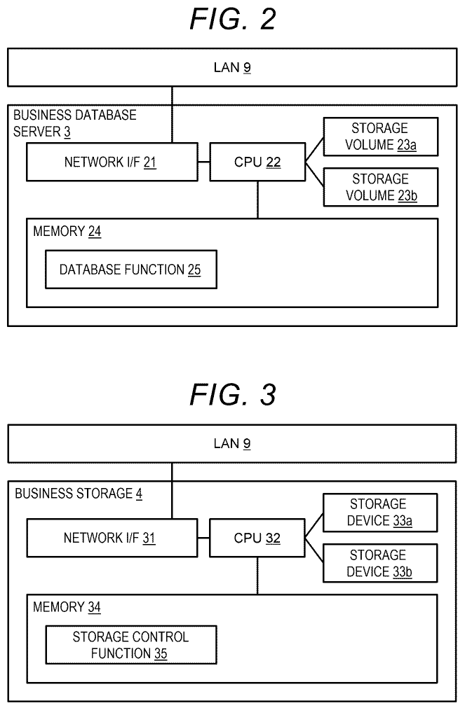

The business database server 3 mainly executes processing of accumulating, in a database, various types of data collected or generated accompanying the operation of the business application server 2. FIG. 2 is a block diagram illustrating a functional configuration of the business database server 3 illustrated in FIG. 1.

As illustrated in FIG. 2, the business database server 3 includes a network interface (I/F) 21 that is communicably connected to the LAN 9 and transmits and receives information to and from an external configuration, a central processing unit (CPU) 22 that executes various types of processing for serving as the business database server 3, storage volumes 23a and 23b that store various types of data, and a memory 24 that stores a database function 25 that is a program for causing the CPU 22 to execute processing for serving as a database.

The storage volumes 23a and 23b are storage areas provided and mounted from the business storage 4. The CPU 22 implementing the database function 25 stores data in the storage volumes 23a and 23b or performs processing of reading data from the storage volumes 23a and 23b.

The business storage 4 mainly stores data provided from the business database server 3 and executes processing of providing the stored data in response to a read request from the business database server 3. FIG. 3 is a block diagram illustrating a functional configuration of the business storage 4 illustrated in FIG. 1.

As illustrated in FIG. 3, the business storage 4 includes a network interface (I/F) 31 that is communicably connected to the LAN 9 and transmits and receives information to and from an external configuration, a central processing unit (CPU) 32 that executes various types of processing for serving as the storage 4, storage devices 33a and 33b that store various types of data, and a memory 34 that stores a storage control function 35 that is a program for causing the CPU 32 to execute processing for serving as a storage. At least a part of the storage devices 33a and 33b is provided as the storage volumes 23a and 23b of the business database server 3 as described above.

The CPU 32 implementing the storage control function 35 stores data in the storage devices 33a and 33b in response to a write request from the business database server 3, and performs processing of reading data from the storage devices 33a and 33b in response to a read request from the business database server 3.

In the above description, an example in which the business application server 2, the business database server 3, and the business storage 4 constituting the business system are constructed on the cloud 1 is described, and these components may be operated as so-called on-premises, using computer equipment physically installed on the premises managed by a system manager or the like. As described above, the configuration of the embodiment can also be implemented by using a hybrid cloud that is a combination of on-premises and a cloud.

Next, the data migration system will be described.

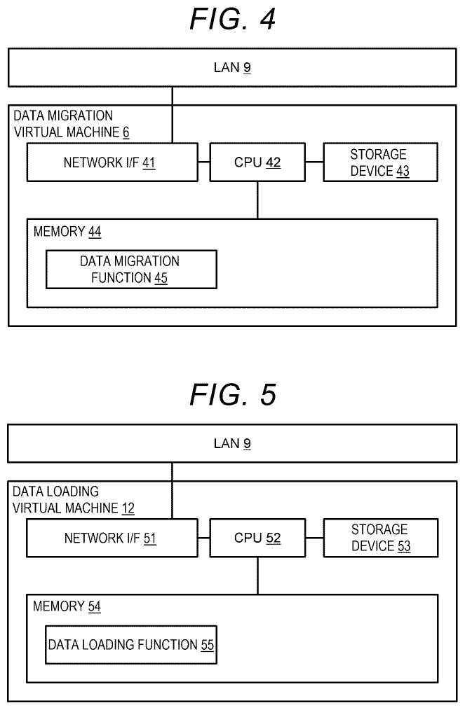

The data migration service server 5 in the data migration system includes a data migration virtual machine 6. The data migration virtual machine 6 performs processing of periodically monitoring a change in data stored in the business database server 3, extracting change data, which is difference data changed with respect to original data, and storing the change data in the change data storage 7. FIG. 4 is a block diagram illustrating a functional configuration of the data migration virtual machine 6 illustrated in FIG. 1.

As illustrated in FIG. 4, the data migration virtual machine 6 includes a network interface (I/F) 41 that is communicably connected to the LAN 9 and transmits and receives information to and from an external configuration, a central processing unit (CPU) 42 that executes various types of processing for serving as the data migration virtual machine 6, a storage device 43 that stores various types of data, and a memory 44 that stores a data migration function 45 that is a program for causing the CPU 42 to execute processing for serving as the data migration virtual machine.

The change data storage 7 includes a change data file 8 that stores change data extracted by the data migration virtual machine 6. Here, details of an information table included in the change data file 8 will be described with reference to FIG. 7.

As illustrated in FIG. 7, the information table included in the change data file 8 includes a “change type”, a “table name”, a “change content”, and a “change date and time” as data items, and each piece of change data generated by the data migration virtual machine 6 includes information regarding these items.

The change type includes update, insertion, and deletion. The “update” indicates a case where data already stored in the business database server 3 is changed, the “insertion” indicates a case where data is newly stored in the business database server 3, and the “deletion” indicates a case where data already stored in the business database server 3 is deleted. The table name indicates a table (a table in which data was stored in the case of deletion) in which the data is stored in the business database server 3. The change content indicates contents of changed data. For example, the change content indicates contents of updated data when the change type is “update”, contents of newly inserted data when the change type is “insertion”, and contents of deleted data when the change type is “deletion”. In the example illustrated in FIG. 7, a first numerical value (35099, 998, 1792) in each piece of data of the change content indicates a row number where data content is changed among rows describing data. The change date and time indicates a date and time when a change (update, insertion, or deletion) of data occurs. As described above, in the change data storage 7, the data migration virtual machine 6 records, as the change data file 8, difference data (in particular, the “change content”) that is difference between data before being changed and data after being changed by the business system, and a change time point (the “change date and time”) that is a time point when the change occurs.

Next, the analysis system will be described.

The analysis tool 10 in the analysis system performs processing of reading and analyzing data stored in the analysis database 11. The analysis processing executed by the analysis tool 10 differs depending on the data to be analyzed, and is, for example, analysis relating to a cash transaction history when the data to be analyzed is banking business data, or analysis relating to a stock transaction history when the data to be analyzed is stock transaction business data.

The analysis database 11 in the analysis system includes a data loading virtual machine 12 that executes processing of reading the change data file 8 from the change data storage 7 and storing the change data file 8 in an analysis database storage 13, and the analysis database storage 13 that stores the change data file 8 read by the data loading virtual machine 12. As described above, the data loading virtual machine 12 reflects, in data stored in the analysis database storage 13 of the analysis system, the difference data stored in the change data file 8.

FIG. 5 is a block diagram illustrating a functional configuration of the data loading virtual machine 12 illustrated in FIG. 1. As illustrated in FIG. 5, the data loading virtual machine 12 includes a network interface (I/F) 51 that is communicably connected to the LAN 9 and transmits and receives information to and from an external configuration, a central processing unit (CPU) 52 that executes various types of processing for serving as the data loading virtual machine 12, a storage device 53 that stores various types of data, and a memory 54 that stores a data loading function 55 that is a program for causing the CPU 52 to execute processing for serving as the data loading virtual machine.

Next, the management system will be described.

The management server 14 constituting the management system mainly executes processing of determining whether freshness of data that is not taken into the analysis database 11 in the change data file 8 stored in the change data storage 7 is lower than a predetermined freshness threshold, further comparing CPU utilization and/or network utilization of the data loading virtual machine 12 or the data migration virtual machine 6 with a predetermined threshold requirement, and scaling (scaling up, scaling down, or maintaining the size of) the virtual machine according to the comparison result. FIG. is a block illustrating diagram a functional 6 configuration of the management server 14 illustrated in

FIG. 1.

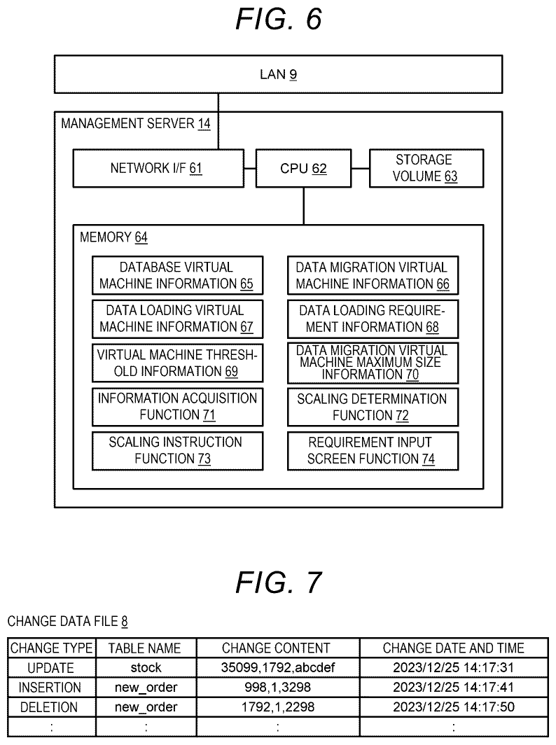

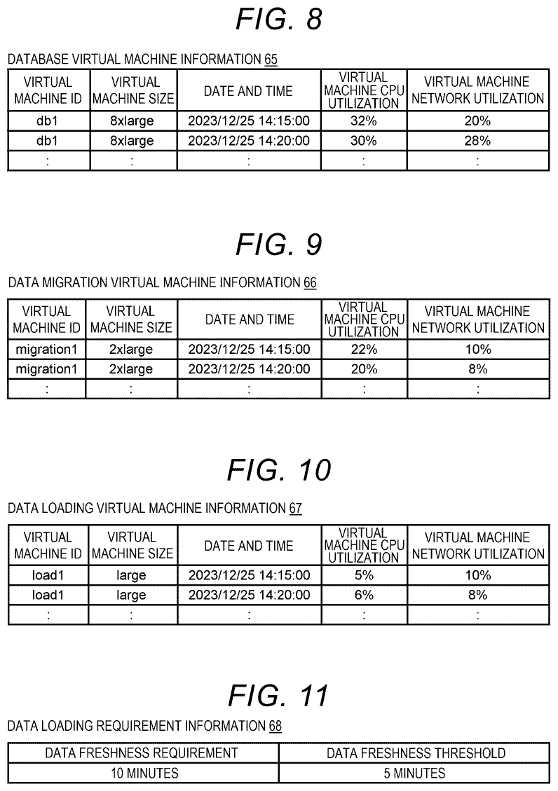

As illustrated in FIG. 6, the management server includes 14 a network interface (I/F) 61 that is communicably connected to the LAN 9 and transmits and receives information to and from an external configuration illustrated in FIG. 1, a central processing unit (CPU) 62 that performs various types of processing for serving as the management server 14, a storage volume 63 that stores various types of data, and a memory 64 that stores programs and information for causing the CPU 62 to perform processing for serving as the management server. The memory 64 of the management server 14 stores, as various types of information, database virtual machine information 65, data migration virtual machine information 66, data loading virtual machine information 67, data loading requirement information 68, virtual machine threshold information 69, and data migration virtual machine maximum size information 70. The memory 64 stores, as various programs, an information acquisition function 71, a scaling determination function 72, a scaling instruction function 73, and a requirement input screen function 74. Here, the various types of information will be described with reference to FIGS. 8 to 13.

FIG. 8 is a diagram illustrating an information table of the database virtual machine information 65 stored in the memory 64 of the management server 14 illustrated in FIG. 6. As illustrated in FIG. 8, the database virtual machine information 65 includes a “virtual machine ID”, a “virtual machine size”, a “date and time”, “virtual machine CPU utilization”, and “virtual machine network utilization” as information items.

The virtual machine ID in the database virtual machine information 65 is identification information on a database virtual machine that functions as the business database server 3 constructed on the cloud 1. The virtual machine size is information indicating a size of the database virtual machine corresponding to the identification information. The virtual machine size has “1xlarge” as a basic size, and the magnitude thereof is indicated by the number of times the basic size. In the example illustrated in FIG. 8, “8xlarge” is exemplified, which indicates that the virtual machine size is eight times the basic size. The date and time indicates a date and time when the database virtual machine information is acquired. The virtual machine CPU utilization indicates CPU utilization of the database virtual machine corresponding to the identification information at the date and time, and the virtual machine network utilization indicates network communication utilization used by the database virtual machine. The utilization is referred to as an indicator showing a load on the business database server 3 at the date and time.

FIG. 9 is a diagram illustrating an information table of the data migration virtual machine information 66 stored in the memory 64 of the management server 14 illustrated in FIG. 6. As illustrated in FIG. 9, the data migration virtual machine information 66 also includes, as information items, the “virtual machine ID”, the “virtual machine size”, the “date and time”, the “virtual machine CPU utilization”, and the “virtual machine network utilization”.

The virtual machine ID in the data migration virtual machine information 66 is identification information on a virtual machine that functions as the data migration virtual machine 6 constructed on the cloud 1. The virtual machine size is information indicating a size of the data migration virtual machine corresponding to the identification information. The date and time indicates a date and time when the data migration virtual machine information is acquired. The virtual machine CPU utilization indicates CPU utilization of the data migration virtual machine 6 corresponding to the identification information at the date and time, and the virtual machine network utilization indicates network communication utilization used by the data migration virtual machine 6. The utilization referred to as an indicator indicating a load on the data migration virtual machine 6 at the date and time.

FIG. 10 is a diagram illustrating an information table of the data loading virtual machine information 67 stored in the memory 64 of the management server 14 illustrated in FIG. 6. As illustrated in FIG. 10, the data loading virtual machine information 67 also includes, as information items, the “virtual machine ID”, the “virtual machine size”, the “date and time”, the “virtual machine CPU utilization”, and the “virtual machine network utilization”.

The virtual machine ID in the data loading virtual machine information 67 is identification information on a virtual machine that functions as the data loading virtual machine 12 constructed on the cloud 1. The virtual machine size is information indicating a size of the data loading virtual machine corresponding to the identification information. The date and time indicates a date and when the data loading virtual machine information is acquired. The virtual machine CPU utilization indicates CPU utilization of the data loading virtual machine 12 corresponding to the identification information at the date and time, and the virtual machine network utilization indicates network communication utilization used by the data loading virtual machine 12. The utilization is referred to as an indicator indicating a load on the data loading virtual machine 12 at the date and time.

FIG. 11 is a diagram illustrating an information table of the data loading requirement information 68 stored in the memory 64 of the management server 14 illustrated in FIG. 6. As illustrated in FIG. 11, the data loading requirement information 68 includes a “data freshness requirement” and a “data freshness threshold” as information items.

The data freshness requirement defines a minimum time interval at which information updated in the business database server 3 of the business system is to be reflected in the analysis database 11 of the analysis system. In the example illustrated in FIG. 11, the data freshness requirement is set to “10 minutes” as an example, which means that, when information is updated in the business database server 3, it is essential to reflect the updated information in the analysis database 11 within 10 minutes.

The data freshness threshold determines a boundary value for freshness of data stored in the analysis system, and defines a threshold for determining whether to execute processing of reflecting updated information in the analysis database 11 in accordance with the data freshness requirement. The freshness of data is a difference between an update time point indicating a time point when data is updated in the business system and a current time point. The data freshness threshold is also a value that defines an upper limit value of the difference. In the example illustrated in FIG. 11, the data freshness threshold is set to “5 minutes” as an example, which means that the processing of reflecting the updated information in the analysis database 11 should be executed when 5 minutes is elapsed since the information is updated in the business database server 3.

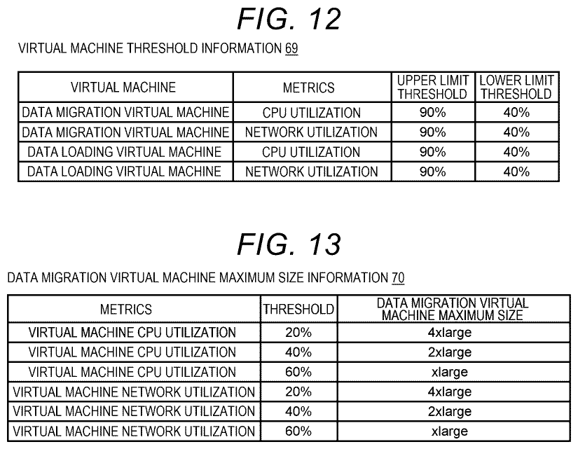

FIG. 12 is a diagram illustrating an information table of the virtual machine threshold information 69 stored in the memory 64 of the management server 14 illustrated in FIG. 6. As illustrated in FIG. 12, the virtual machine threshold information 69 includes a “virtual machine”, “metrics”, an “upper limit threshold”, and a “lower limit threshold” as information items.

The virtual machine defines a target virtual machine for a which threshold is to be defined. Specifically, the target virtual machine for which a threshold is to be defined is the data migration virtual machine 6 or the data loading virtual machine 12. The metrics define the CPU utilization or the network utilization as a target for which a threshold is defined. The upper limit threshold and the lower limit threshold define an upper limit and a lower limit for the threshold of the defined metrics, respectively. The upper limit threshold determines an upper limit of the load on the virtual machines 6 and 12, and is used as a determination reference for scaling up the virtual machines when the load exceeds the defined numerical value. The lower limit threshold determines a lower limit of the load on the virtual machines 6 and 12, and is used as a determination reference for scaling down the virtual machines when the load falls below the defined numerical value.

FIG. 13 is a diagram illustrating an information table of the data migration virtual machine maximum size information 70 stored in the memory 64 of the management server 14 illustrated in FIG. 6. The data migration virtual machine maximum size information 70 determines an upper limit of a resource scale of the data migration virtual machine 6 in association with the machine load on the business database server 3 in the business system. As illustrated in FIG. 13, the data migration virtual machine maximum size information a 70 includes “metrics,” “threshold,” and a “data migration virtual machine maximum size” as information items.

The metrics define the CPU utilization or the virtual machine network utilization of the database virtual machine as a target for which a threshold and a data migration virtual machine maximum size are defined. The threshold and the data migration virtual machine maximum size define a threshold of the defined metrics and a data migration virtual machine maximum size corresponding to the threshold. Referring to examples shown in an uppermost section of the table in FIG. 13 in order, it is defined that the data migration virtual machine size may be increased to “4xlarge” at maximum when the CPU utilization of the database virtual machine is up to 20%, the data migration virtual machine size may be increased to “2xlarge” at maximum when the CPU utilization of the database virtual machine is up to 40%, and the data migration virtual machine size is “1xlarge” at maximum when the CPU utilization of the database virtual machine exceeds 60%.

Next, various programs stored in the memory 64 will be described.

The information acquisition function 71 stored in the memory 64 is a program for causing the CPU 62 of the management server 14 to execute processing of communicating with the business database server 3 of the business system, the data migration virtual machine 6 of the data migration system, and the data loading virtual machine 12 of the analysis system to acquire the database virtual machine information 65 described with reference to FIG. 8, the data migration virtual machine information 66 described with reference to FIG. 9, and the data loading virtual machine information 67 described with reference to FIG. 10, respectively.

The scaling determination function 72 is a program for causing the CPU 62 of the management server 14 to execute processing of determining whether to scale up or scale down the virtual machines 6 and 12 depending on whether the CPU utilization or the network utilization of the data migration virtual machine 6 and the data loading virtual machine 12 is higher than the upper limit threshold or lower than the lower limit threshold defined in the virtual machine threshold information 69 described with reference to FIG. 12, and further depending on whether the data migration virtual machine size in the case of being scaled up is a size larger than the data migration virtual machine maximum size.

The scaling instruction function 73 is a program for causing the CPU 62 of the management server 14 to execute processing of instructing scale-up or scale-down for the virtual machines 6 and 12 that are determined by the scaling determination function 72 to scale up or scale down.

The requirement input screen function 74 is a program for causing the CPU 62 of the management server 14 to execute processing of displaying a screen for receiving a requirement input on a display device of the management server 14 or a display device of a terminal device of a manager connected to the management server 14 via the LAN 9, and processing of implementing a user interface for receiving requirements input from an input device of the management server 14 or an input device of the terminal device of the manager operated by the manager.

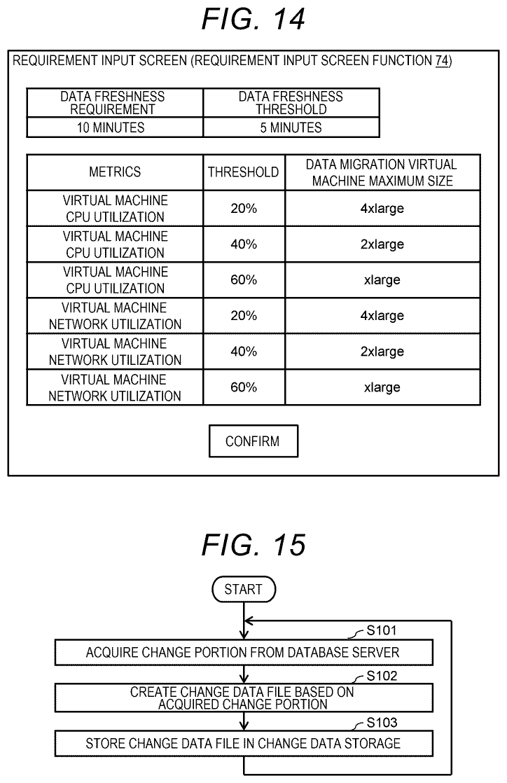

FIG. 14 is a diagram illustrating an example of a requirement input screen displayed on the display device of the management server 14 or the display device of the terminal device of the manager by executing the requirement input screen function 74 by the CPU 62 of the management server 14. As illustrated in FIG. 14, the requirement input screen includes, as an example, a column for receiving an input of the “data freshness requirement” and the “data freshness threshold” of the data loading requirement information 68 described with reference to FIG. 11, a column for receiving an input of the “metrics”, the “threshold”, and the “data migration virtual machine maximum size” of the data migration virtual machine maximum size information 70 described with reference to FIG. 13, and a “confirm” button for confirming input information after the inputs are completed. On the requirement input screen displayed on the display device of the management server 14 or the display device of the terminal device of the manager, the manager can input the requirements in the respective columns using an input device such as a keyboard and finally perform an operation of pressing the confirm button, whereby the requirements can be input.

Next, an operation of each system in the embodiment will be described.

First, the operation of the data migration system including the data migration service server 5 and the change data storage 7 illustrated in FIG. 1 will be described. FIG. 15 is a flowchart illustrating processing of a data migration service performed by the data migration system.

As illustrated in FIG. 15, first, in step S101, the data migration virtual machine 6 of the data migration service server 5 accesses the business database server 3 of the business system via the LAN 9, and acquires a data portion (change data), which is changed from the previous access time point, from the business database server 3. The acquired change data can be at least temporarily stored in the storage device 43 of the data migration virtual machine 6.

Next, in step S102, the data migration virtual machine 6 creates the change data file 8 based on the change data acquired in step S101. As described with reference to FIG. 7, the change data file 8 created by the data migration virtual machine 6 includes information items, that is, the change type (update, insertion, and deletion), the table name, the change content, and the change date and time.

Finally, in step the data migration virtual machine 6 stores the change data file 8 generated in step S102 in the change data storage 7.

The data migration virtual machine 6 repeatedly executes the processing of steps S101 to S103 described above. In this way, the data migration system sequentially acquires the change data from the business database server 3 and accumulates the change data in the change data file 8 of the change data storage 7. Next, the operation of the analysis database 11

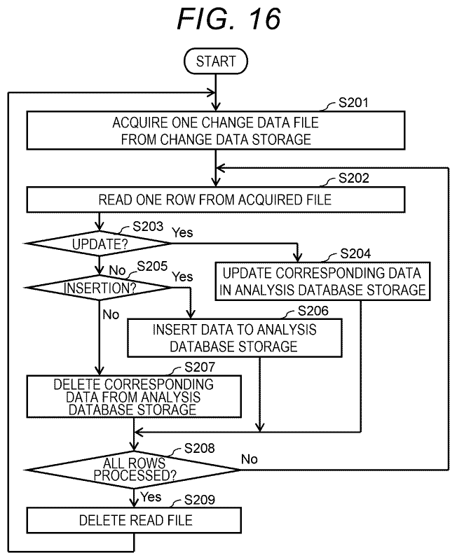

illustrated in FIG. 1 will be described. FIG. 16 is a flowchart illustrating data loading processing performed by the analysis database 11. As a prerequisite for the data loading processing described here, all data stored in the business database server 3 is first taken as initial data and loaded into the analysis database storage 13 by the data loading virtual machine 12. Thereafter, only updated data is taken as difference data with respect to the initial data, and is supplied to the analysis database storage 13 by the data loading processing described here.

As illustrated in FIG. 16, first in step S201, the data loading virtual machine 12 of the analysis database 11 accesses the change data storage 7 of the data migration system via the LAN 9, and acquires one change data file 8 from change data files 8 stored in the change data storage 7. The acquired change data file 8 can be at least temporarily stored in the storage device 53 of the data loading virtual machine 12.

In step S202, the data loading virtual machine 12 reads one row of data from the change data file 8 acquired in step S201.

Next, in step S203, the data loading virtual machine 12 determines whether the data is “update” data based on the change type information included in the one row of data read in step S202. If the data is “update” data (Yes), the processing proceeds to step S204, and the data loading virtual machine 12 updates the corresponding data in the analysis database storage 13.

On the other hand, if the data is not “update” data (No), the processing proceeds to step S205, and the data loading virtual machine 12 determines whether the data is “insertion” data based on the change type information included in the one row of data read in step S202.

If the data is “insertion” data (Yes), the processing proceeds to step S206, and the data loading virtual machine 12 inserts the data into the analysis database storage 13. If the data is not “insertion” data (No), the data is “deletion” data of the remaining change type, and the processing proceeds to step $207, and the data loading virtual machine 12 deletes the data from the analysis database storage 13.

Next, in step S208 following the processing of steps S204, S206, and S207, the data loading virtual machine 12 determines whether the processing of steps S202 to S207 is executed for all rows of data in the change data file 8 acquired in step S201. If the processing is not executed for all rows of data (No), the processing returns to step S202, and the above-described processing is executed for other rows of data in the change data file 8.

If the processing is executed for all rows of data (Yes), the processing proceeds to step S209, and the data loading virtual machine 12 deletes the change data file 8 acquired in step S201 from the storage device 53. Thereafter, the processing returns to step S201, and the data loading virtual machine 12 acquires one change data file 8, which is different from the former one, from the change data files 8 stored in the change data storage 7, and executes the subsequent processing in the same manner.

In this way, the data loading virtual machine 12 changes the data stored in the analysis database storage 13 according to the change data file 8, and maintains the data freshness in a manner of substantially synchronizing with the data in the business database server 3.

Next, the operation of the management server 14

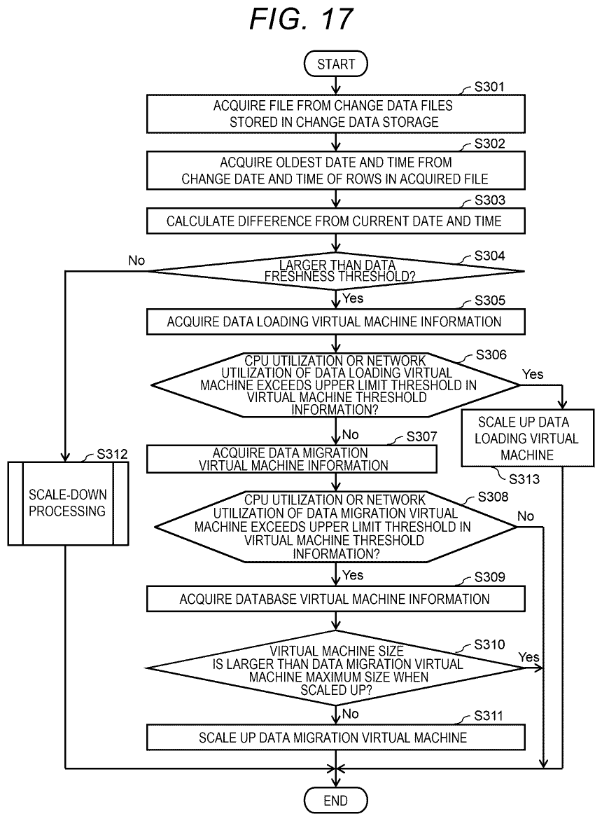

illustrated in FIG. 1 will be described. FIG. 17 is a flowchart illustrating processing in which the management server 14 executes scaling of a virtual machine.

As illustrated in FIG. 17, first, in step S301, the CPU 62 of the management server 14 executes the information acquisition function 71 stored in the memory 64, accesses the change data storage 7 via the LAN 9, and acquires one change data file 8 from the change data files 8 stored in the change data storage 7. The acquired change data file 8 can be at least temporarily stored in the storage volume 63 of the management server 14.

Next, in step S302, the CPU 62 of the management server 14 executes the information acquisition function 71, refers to the change date and time information of each row of data in the acquired change data file 8, and acquires the oldest date and time among them.

Next, in step S303, the CPU 62 of the management server 14 executes the information acquisition function 71 and calculates a difference between the oldest date and time in the change data file 8 acquired in step S302 and the current date and time. Current date and time information can be acquired from a clock function of the CPU 62 itself.

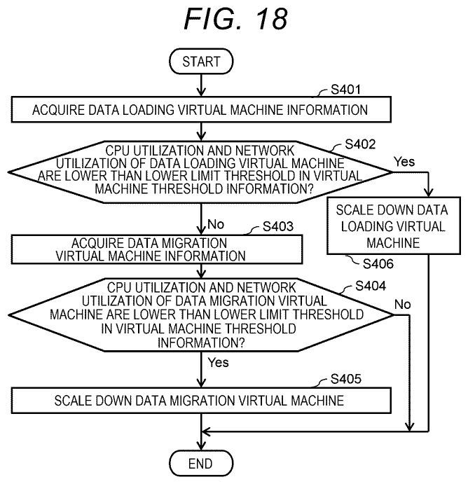

Next, in step S304, the CPU 62 of the management server 14 executes the information acquisition function 71, and determines whether the difference between the oldest date and time in the change data file 8 and the current date and time calculated in step S303 is larger than the data freshness threshold defined in the data loading requirement information 68 stored in the memory 64. If the difference is larger than the data freshness threshold, it means that the data freshness of the change data file 8 is low, and if the difference is equal to or smaller than the data freshness threshold, it means that the data freshness of the change data file 8 is high. If the difference is larger than the data freshness threshold (Yes), the processing proceeds to step S305, and if the difference is equal to or smaller than the data freshness threshold (No), the processing proceeds to step S312. Details of the processing of step $312 relating to scale-down processing of the virtual machines 6 and 12 will be described later with reference to FIG. 18.

In step S305, the CPU 62 of the management server

14 executes the information acquisition function 71, accesses the data loading virtual machine 12 via the LAN 9, and acquires the data loading virtual machine information 67 described with reference to FIG. 10 from the data loading virtual machine 12. The acquired data loading virtual machine information 67 can be at least temporarily stored in the memory 64 of the management server 14.

Next, in step S306, the CPU 62 of the management server 14 executes the scaling determination function 72, and determines whether the CPU utilization or the network utilization of the data loading virtual machine 12 included in the data loading virtual machine information 67 acquired in step S305 exceeds a corresponding upper limit threshold defined in the virtual machine threshold information 69 (see FIG. 12) stored in the memory 64. The CPU utilization or the network utilization of the data loading virtual machine 12 exceeding the upper limit threshold means that the resource scale of the data loading virtual machine 12 is insufficient.

If CPU the utilization or the network utilization of the data loading virtual machine 12 exceeds the upper limit threshold defined in the virtual machine threshold information 69 (Yes), the processing proceeds to step S313. In step S313, the CPU 62 of the management server 14 executes the scaling instruction function 73 and executes processing of scaling up the data loading virtual machine 12 by one level. In the scale-up of the virtual machine, the virtual machine size is increased in stepwise multiplication like “2xlarge”, “4xlarge”, and “8xlarge” with respect to “1xlarge” of the virtual machine reference size. In contrast, in scale-down of the virtual machine, the virtual machine size is reduced stepwise half by half. In step S313, the CPU 62 of the management server 14 executes the processing of scaling up the virtual machine size by one level by doubling the current virtual machine size of the data loading virtual machine 12. After step S313, the processing flow illustrated in FIG. 17 ends.

On the other hand, if neither the CPU utilization nor the network utilization of the data loading virtual machine 12 exceeds the upper limit threshold defined in the virtual machine threshold information 69 (No), the processing proceeds to step S307 in a state where the virtual machine size of the data loading virtual machine 12 at the current time point is maintained without performing the scaling processing of the data loading virtual machine 12.

In step S307, the CPU 62 of the management server 14 executes the information acquisition function 71, accesses the data migration virtual machine 6 via the LAN 9, and acquires the data migration virtual machine information 66 described with reference to FIG. 9 from the data migration virtual machine 6. The acquired data migration virtual machine information 66 can be at least temporarily stored in the memory 64 of the management server 14.

Next, in step S308, the CPU 62 of the management server 14 executes the scaling determination function 72, and determines whether the CPU utilization or the network utilization of the data migration virtual machine 6 included in the data migration virtual machine information 66 acquired in step S307 exceeds a corresponding upper limit threshold defined in the virtual machine threshold information 69 (see FIG. 12) stored in the memory 64. The CPU utilization or the network utilization of the data migration virtual machine 6 exceeding the upper limit threshold means that the resource scale of the data migration virtual machine 6 is insufficient.

If the CPU utilization or network the utilization of the data migration virtual machine 6 exceeds the upper limit threshold defined in the virtual machine threshold information 69 (Yes), the processing proceeds to step S309. On the other hand, neither the CPU utilization nor the network utilization of the data migration virtual machine 6 exceeds the upper limit threshold defined in the virtual machine threshold information 69 (No), and the processing flow illustrated in FIG. 17 is ended in a state where the current virtual machine size of the data migration virtual machine 6 is maintained without performing the scaling processing of the data migration virtual machine 6.

Next, in step S309, the CPU 62 of the management server 14 executes the information acquisition function 71, accesses the business database server 3 via the LAN 9, and acquires the database virtual machine information 65 described with reference to FIG. 8 from the business database server 3. The acquired database virtual machine information 65 can be at least temporarily stored in the memory 64 of the management server 14.

Next, in step S310, the CPU 62 of the management server 14 executes the scaling determination function 72, refers to the CPU utilization and the network utilization of the business database server 3 (database virtual machine) acquired in step S309 and the data migration virtual machine maximum size information 70 described with reference to FIG. 13, and determines whether the virtual machine size of the scaled up data migration virtual machine 6 in the case of being scaled up is a virtual machine size larger than the data migration virtual machine maximum size determined in the data migration virtual machine maximum size information 70. The processing of step S310 is performed to prevent the load on the business database server 3 (database virtual machine) in advance from exceeding an acceptable level as a result of scaling up the virtual machine size of the data migration virtual machine 6.

Referring to the example illustrated in FIG. 13 as an example, when the acquired CPU utilization of the business database server 3 (database virtual machine) is 40%, the allowable data migration virtual machine maximum size is “2xlarge”. In a case where the virtual machine size of the data migration virtual machine 6 is already “2xlarge” at this time point, if scaled up by one level from “2xlarge”, the virtual machine size is “4xlarge”, which exceeds the allowable data migration virtual machine maximum size. Alternatively, when the acquired network utilization of the business database server 3 (database virtual machine) is 20%, the allowable data migration virtual machine maximum size is “4xlarge”. In a case where the virtual machine size of the data migration virtual machine 6 is “2xlarge” at this time point, even if scaled up by one level from “2xlarge”, the virtual machine size is “4xlarge”, and thus does not exceed the allowable data migration virtual machine maximum size.

In a case where the data migration virtual machine 6 is scaled up, if the virtual machine size of the data migration virtual machine 6 after the scale-up is a virtual machine size larger than the data migration virtual machine maximum size determined in the data migration virtual machine maximum size information 70 (Yes), the scaling processing of the data migration virtual machine 6 is not performed in order to prevent the business database server 3 (database virtual machine) from being overloaded, and the processing flow illustrated in FIG. 17 is ended in a state where the virtual machine size of the data migration virtual machine 6 at the current time point is maintained.

On the other hand, in the case where the data migration virtual machine 6 is scaled up, if the virtual machine size of the data migration virtual machine 6 after the scale-up is not a virtual machine size larger than the data migration virtual machine maximum size determined in the data migration virtual machine maximum size information 70 (No), the business database server 3 (database virtual machine) is not overloaded even when the data migration virtual machine 6 is scaled up, and therefore the processing proceeds to step S311. In step S311, the CPU 62 of the management server 14 executes the scaling instruction function 73 and executes the processing of scaling up the data migration virtual machine 6 by one level, and then ends the processing flow shown in FIG. 17.

As described above, according to the processing in which the management server 14 executes the scaling of the virtual machine in the embodiment described with reference to FIG. 17, when the freshness of the data stored in the analysis system is low, the scaling processing (scale-up, scale-down, or size maintenance) of the virtual machines 6 and 12 is performed according to the load (for example, the CPU utilization or the network utilization) of the virtual machines 6 and 12, and thus the resource scale of the virtual machines 6 and 12 can be dynamically changed as necessary. Accordingly, it is possible to reduce the cost of the resources used for loading data from the business system to the analysis system while securing sufficient freshness of the data supplied to the analysis database storage 13 in the analysis system. Consequently, since power consumption required for loading data is reduced, it is possible to reduce the CO2 emission, achieving a contribution to a reduction in environmental load.

Further, in the case where the data migration virtual machine 6 is scaled up, it is determined whether the virtual machine size of the data migration virtual machine 6 after the scale-up is a virtual machine size larger than the data migration virtual machine maximum size determined in the data migration virtual machine maximum size information 70, and the data migration virtual machine 6 is scaled up only when the virtual machine size does not exceed the data migration virtual machine maximum size. Accordingly, the business database server 3 (database virtual machine) can be prevented from being overloaded in advance when the data migration virtual machine 6 is scaled up, thereby protecting the business database server 3.

The processing flow illustrated in FIG. 17 is preferably repeatedly executed at a time interval shorter than the time determined in the data freshness requirement. As an example, when the time determined in the data freshness requirement is set to 10 minutes as illustrated in FIG. 14, the processing flow illustrated in FIG. 17 may be executed, for example, every minute.

Next, the downscaling processing of step S312 in

the processing flow of FIG. 17 will be described in detail with reference to FIG. 18. FIG. 18 is a flowchart illustrating processing in which the management server 14 executes scaling down of a virtual machine.

In step S304 of the processing flow illustrated in FIG. 17, when it is determined that the difference between the oldest date and time in the change data file 8 and the current date and time, which is calculated in step S303, is equal to or smaller than the data freshness threshold defined in the data loading requirement information 68 stored in the memory 64 (No), the processing proceeds to step S401 in the processing flow illustrated in FIG. 18. The processing of steps S401 to S406 in the processing flow illustrated in FIG. 18 corresponds to the scale-down processing of step S312 in the processing flow in FIG. 17.

In step S401, the CPU 62 of the management server

14 executes the information acquisition function 71, accesses the data loading virtual machine 12 via the LAN 9, and acquires the data loading virtual machine information 67 described with reference to FIG. 10 from the data loading virtual machine 12. The acquired data loading virtual machine information 67 can be at least temporarily stored in the memory 64 of the management server 14.

Next, in step S402, the CPU 62 of the management server 14 executes the scaling determination function 72, and determines whether the CPU utilization and the network utilization of the data loading virtual machine 12 included in the data loading virtual machine information 67 acquired in step S401 are lower than the respective lower limit thresholds defined in the virtual machine threshold information 69 (see FIG. 12) stored in the memory 64. The CPU utilization and the network utilization of the data loading virtual machine 12 being lower than the lower limit thresholds means that the resource scale of the data loading virtual machine 12 is sufficient and there is room for downscaling.

If both the CPU utilization and the network utilization of the data loading virtual machine 12 are lower than the lower limit threshold defined in the virtual machine threshold information 69 (Yes), the processing proceeds to step S406. In step S406, the CPU 62 of the management server 14 executes the scaling instruction function 73 and performs processing of scaling down the data loading virtual machine 12 by one level. After step S406, the processing flow illustrated in FIG. 18 ends.

On the other hand, if at least one of the CPU utilization and the network utilization of the data loading virtual machine 12 is equal to or higher than the corresponding lower limit threshold defined in the virtual machine threshold information 69 (No), the processing proceeds to step S403 in a state where the virtual machine size of the data loading virtual machine 12 at the current time point is maintained without performing the scaling processing of the data loading virtual machine 12.

In step S403, the CPU 62 of the management server 14 executes the information acquisition function 71, accesses the data migration virtual machine 6 via the LAN 9, and acquires the data migration virtual machine information 66 described with reference to FIG. 9 from the data migration virtual machine 6. The acquired data migration virtual machine information 66 can be at least temporarily stored in the memory 64 of the management server 14.

Next, in step S404, the CPU 62 of the management server 14 executes the scaling determination function 72, and determines whether the CPU utilization and the network utilization of the data migration virtual machine 6 included in the data migration virtual machine information 66 acquired in step S403 are lower than the respective lower limit thresholds defined in the virtual machine threshold information 69 (see FIG. 12) stored in the memory 64. The CPU utilization and the network utilization of the data migration virtual machine 6 being lower than the lower limit threshold means that the resource scale of the data migration virtual machine 6 is sufficient and there is room for downscaling.

If both the CPU utilization and the network utilization of the data migration virtual machine 6 are lower than the lower limit threshold defined in the virtual machine threshold information 69 (Yes), the processing proceeds to step S405. On the other hand, if at least one of the CPU utilization and the network utilization of the data migration virtual machine 6 is equal to or higher than the corresponding lower limit threshold defined in the virtual machine information threshold 69 (No), the processing flow illustrated in FIG. 17 is ended in a state where the virtual machine size of the data migration virtual machine 6 at the current time point is maintained without performing the scaling processing of the data migration virtual machine 6.

In step S405, the CPU 62 of the management server 14 executes the scaling instruction function 73 and performs processing of scaling down the data migration virtual machine 6 by one level. After step S405, the processing flow illustrated in FIG. 18 ends.

As described above, according to an embodiment of the present disclosure, there is provided a management system that manages a resource scale of a virtual machine that executes processing for copying data accumulated by a first information system (business system) to a second information system (analysis system). The management server 14 constituting the management system includes the CPU 62 as a processor and the memory 64. The memory 64 stores, in the data loading requirement information 68, a data freshness threshold that determines a boundary value related to freshness of data stored in the analysis database storage 13 of the analysis system serving as the second information system, and a virtual machine load upper limit threshold that determines an upper limit of the load on the virtual machine. When the freshness of data changed in the business system serving as the first information system is lower than the data freshness threshold, the CPU 62 serving as a processor compares the load on the virtual machine with the virtual machine load upper limit threshold, and increases the resource scale of the virtual machine based on the comparison result (see the processing of steps S304 to S306 and S313 in FIG. 17). Accordingly, it is possible to reduce the cost of the resources used for loading the data from the business system serving as the first information system to the analysis system serving as the second information system while securing sufficient freshness of the data to be supplied to the analysis database storage 13 of the analysis system serving as the second information system. Consequently, since power consumption required for loading data is reduced, it is possible to reduce the CO2 a emission, achieving contribution to a reduction in environmental load.

In the management system of the embodiment, the memory 64 further stores, in the virtual machine threshold information 69, a virtual machine load lower limit threshold that defines a lower limit of the load on the virtual machine, and the CPU 62 as a processor compares the load on the virtual machine with the virtual machine load lower limit threshold when freshness of data changed in the first information system is equal to or higher than the data freshness threshold, and reduces a resource scale of the virtual machine based on the comparison result (see the processing of steps S401 to S406 in FIG. 18). Accordingly, it is possible to scale down the virtual machine to reduce the cost of the resources used for loading data from the first information system to the second information system while securing sufficient freshness of the data to be supplied to the analysis database storage 13 of the analysis system serving as the second information system.

Further, in the management system of the embodiment, the virtual machine includes the data migration virtual machine 6 that records difference data that is a difference between data before being changed by the first information system and data after being changed and a change time point that is a time point when the change occurs, and the data loading virtual machine 12 that reflects the difference data in data stored in the second information system. The memory 64 further stores the data migration virtual machine maximum size information 70 that defines an upper limit of a resource scale of the data migration virtual machine 6 in association with a machine load on the business database server 3 in the first information system. When freshness of data changed in the first information system is lower than the data freshness threshold, the CPU 62 serving as the processor of the management system
compares a load on the data loading virtual machine 12 with the virtual machine load upper limit threshold,
   if the load on the data loading virtual machine 12 exceeds the virtual machine load upper limit threshold, increases a resource scale of the data loading virtual machine 12, and
   if the load on the data loading virtual machine 12 does not exceed the virtual machine load upper limit threshold, maintains a current resource scale of the data loading virtual machine 12, and
compares a load on the data migration virtual machine 6 with the virtual machine load upper limit threshold,
   if the load on the data migration virtual machine 6 exceeds the virtual machine load upper limit threshold, compares a resource scale of the data migration virtual machine 6 in an assumed case where the resource scale of the data migration virtual machine 6 is increased with the data migration virtual machine maximum size associated with a current load on the machine of the business database server 3 of the first information system,
   if the resource scale of the data migration virtual machine 6 is not larger than the data migration virtual machine maximum size, increases the resource scale of the data migration virtual machine 6, and
   if the resource scale of the data migration virtual machine 6 is larger than the data migration virtual machine maximum size, maintains a current resource scale of the data migration virtual machine 6, and
   if the load on the data migration virtual machine 6 does not exceed the virtual machine load upper limit threshold, maintains the current resource scale of the data migration virtual machine 6 (see the processing flow in FIG. 17).

Accordingly, it is possible to reduce the cost of resources for performing data migration from the business system and the cost of resources for performing data loading to the analysis system while securing sufficient freshness of data provided to the analysis database storage 13 of the analysis system serving as the second information system.

Further, in the management system of the embodiment, the virtual machine includes the data migration virtual machine 6 that records difference data that is a difference between data before being changed by the first information system and data after being changed and a change time point that is a time point at which the change occurs, and the data loading virtual machine 12 that reflects the difference data in data stored in the second information system. When freshness of data changed in the first information system is equal to or higher than the data freshness threshold, the CPU 62 serving as the processor of the management system
compares a load on the data loading virtual machine
   if the load on the data loading virtual machine 12 is less than the virtual machine load lower limit threshold, reduces a resource scale of the data loading virtual machine 12, and
   if the load on the data loading virtual machine 12 is equal to or greater than the virtual machine load lower limit threshold, maintains a current resource scale of the data loading virtual machine 12, and
compares a load on the data migration virtual machine 6 with the virtual machine load lower limit threshold,
   if the load on the data migration virtual machine 6 is less than the virtual machine load lower limit threshold, reduces a resource scale of the data migration virtual machine 6, and if the load on the data migration virtual machine 6 is equal to or greater than the virtual machine load lower limit threshold, maintains a current resource scale of the data migration virtual machine 6.

Accordingly, it is possible to reduce the cost of resources for performing data migration from the business system and the cost of resources for performing data loading to the analysis system by reducing the resources to scales corresponding to respective loads while securing sufficient freshness of data provided to the analysis database storage 13 of the analysis system serving as the second information system.

In the management system of the embodiment, the load on the virtual machine may be CPU utilization of the virtual machines 6 and 12 and network utilization of the virtual machines 6 and 12. The freshness of data can be a difference between an update time point indicating a time point when data is updated in the first information system and a current time point, and the data freshness threshold can be a value that defines an upper limit value of the difference.

According to another embodiment of the present disclosure, there is provided a management method for allowing a computer to function as a management system that manages a resource scale of a virtual machine that executes processing for copying data accumulated by a first information system to a second information system, the computer including a memory and a processor, the management method including: storing, in the memory, a data freshness threshold that defines a boundary value related to freshness of data stored in the second information system and a virtual machine load upper limit threshold that defines an upper limit of a load on the virtual machine; and causing the processor to compare the load on the virtual machine with the virtual machine load upper limit threshold when freshness of data changed in the first information system is lower than the data freshness threshold, and increase the resource scale of the virtual machine based on a comparison result.

According to another embodiment of the present disclosure, there is provided a management program for causing a computer to execute processing of managing a resource scale of a virtual machine that executes processing for copying data accumulated by a first information system to a second information system, the computer including a memory and a processor. In the memory, a data freshness threshold that defines a boundary value related to freshness of data stored in the second information system and a virtual machine load upper limit threshold that defines an upper limit of a load on the virtual machine are stored. The program causes the processor to compare the load on the virtual machine with the virtual machine load upper limit threshold when freshness of data changed in the first information system is lower than the data freshness threshold, and increase the resource scale of the virtual machine based on a comparison result.

The above-described embodiments of the invention are examples for describing the invention, and are not intended to limit the scope of the invention only to the embodiments. Those skilled in the art can execute the invention in various other embodiments without departing from the scope of the invention.

What is claimed is:

1. A management system for managing a resource scale of a virtual machine that executes processing for copying data accumulated by a first information system to a second information system, the management system comprising:
a processor; and
a memory, wherein
the memory stores a data freshness threshold that defines a boundary value related to freshness of data stored in the second information system and a virtual machine load upper limit threshold that defines an upper limit of a load on the virtual machine, and
the processor compares the load on the virtual machine with the virtual machine load upper limit threshold when freshness of data changed in the first information system is lower than the data freshness threshold, and increases the resource scale of the virtual machine based on a comparison result.

2. The management system according to claim 1, wherein
the memory further stores a virtual machine load lower limit threshold that defines a lower limit of the load on the virtual machine, and
the processor compares the load on the virtual machine with the virtual machine load lower limit threshold when freshness of data changed in the first information system is equal to or higher than the data freshness threshold, and reduces the resource scale of the virtual machine based on a comparison result.

3. The management system according to claim 1, wherein
the virtual machine includes a data migration virtual machine that records difference data that is a difference between data before being changed by the first information system and data after being changed and a change time point that is a time point when the change occurs, and a data loading virtual machine that reflects the difference data in data stored in the second information system,
the memory further stores a data migration virtual machine maximum size that defines an upper limit of a resource scale of the data migration virtual machine in association with a load on a machine of a database in the first information system, and
when freshness of data changed in the first information system lower than the data freshness threshold, the processor
compares a load on the data loading virtual machine with the virtual machine load upper limit threshold,
if the load on the data loading virtual machine exceeds the virtual machine load upper limit threshold, increases a resource scale of the data loading virtual machine, and
if the load on the data loading virtual machine does not exceed the virtual machine load upper limit threshold, maintains a current resource scale of the data loading virtual machine, and
compares a load on the data migration virtual machine with the virtual machine load upper limit threshold,
if the load on the data migration virtual machine exceeds the virtual machine load upper limit threshold, compares a resource scale of the data migration virtual machine in an assumed case where the resource scale of the data migration virtual machine is increased with the data migration virtual machine maximum size associated with a current load on the machine of the database of the first information system,
if the resource scale of the data migration virtual machine is not larger than the data migration virtual machine maximum size, increases the resource scale of the data migration virtual machine, and
if the resource scale of the data migration virtual machine is larger than the data migration virtual machine maximum size, maintains a current resource scale of the data migration virtual machine, and
if the load on the data migration virtual machine does not exceed the virtual machine load upper limit threshold, maintains the current resource scale of the data migration virtual machine.

4. The management system according to claim 2, wherein
the virtual machine includes a data migration virtual machine that records difference data that is a difference between data before being changed by the first information system and data after being changed and a change time point that is a time point of change, and a data loading virtual machine that reflects the difference data in data stored in the second information system, and
when freshness of data changed in the first information system is equal to or higher than the data freshness threshold, the processor
compares a load on the data loading virtual machine with the virtual machine load lower limit threshold,
if the load on the data loading virtual machine is less than the virtual machine load lower limit threshold, reduces a resource scale of the data loading virtual machine, and
if the load on the data loading virtual machine is equal to or greater than the virtual machine load lower limit threshold, maintains a current resource scale of the data loading virtual machine, and
compares a load on the data migration virtual machine with the virtual machine load lower limit threshold,
if the load on the data migration virtual machine is less than the virtual machine load lower limit threshold, reduces a resource scale of the data migration virtual machine, and
if the load on the data migration virtual machine is equal to or greater than the virtual machine load lower limit threshold, maintains a current resource scale of the data migration virtual machine.

5. The management system according to claim 1, wherein
the load on the virtual machine is CPU utilization of the virtual machine and network utilization of the virtual machine.

6. The management system according to claim 1, wherein
the freshness of data is a difference between an update time point indicating a time point when data is updated in the first information system and a current time point, and
the data freshness threshold is a value that defines an upper limit value of the difference.

7. A management method for allowing a computer to function as a management system that manages a resource scale of a virtual machine that executes processing for copying data accumulated by a first information system to a second information system, the computer including a memory and a processor, the management method comprising:
storing, in the memory, a data freshness threshold that defines a boundary value related to freshness of data stored in the second information system and a virtual machine load upper limit threshold that defines an upper limit of a load on the virtual machine; and
causing the processor to compare the load on the virtual machine with the virtual machine load upper limit threshold when freshness of data changed in the first information system is lower than the data freshness threshold, and increase the resource scale of the virtual machine based on a comparison result.

8. A management program for causing a computer to execute processing of managing a resource scale of a virtual machine that executes processing for copying data accumulated by a first information system to a second information system, the computer including a memory and a processor, wherein
in the memory, a data freshness threshold that defines a boundary value related to freshness of data stored in the second information system and a virtual machine load upper limit threshold that defines an upper limit of a load on the virtual machine are recorded, and
the program causes the processor to compare the load on the virtual machine with the virtual machine load upper limit threshold when freshness of data changed in the first information system is lower than the data freshness threshold, and increase the resource scale of the virtual machine based on a comparison result.
